(19) United States
(12) Patent Application Publication
(10) Pub. No.: US 2010/0088723 A1
(43) Pub. Date: Apr. 8, 2010

(54) BROADCAST RECEIVER, AND CONTROL METHOD FOR BROADCAST RECEIVER

(75) Inventor: Hironao Ito, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/574,400

(22) Filed: Oct. 6, 2009

(30) Foreign Application Priority Data
Oct. 8, 2008 (JP) 2008-262239

(51) Int. Cl. H04N 5/445; H04N 7/173

(52) U.S. Cl. 725/40; 725/55; 725/48

(57) ABSTRACT

The broadcast receiver includes a storage unit configured to store first broadcast information for specifying a broadcast channel and/or program viewable on the broadcast receiver, an acquisition unit configured to acquire second broadcast information from the other broadcast receiver for specifying a broadcast channel and/or program viewable on the other broadcast receiver, an extraction unit configured to extract a broadcast channel and/or program from the first and second broadcast information not viewable on the broadcast receiver and viewable on the other broadcast receiver, and a generation unit configured to generate an electronic program guide that a user can distinguish a broadcast channel and/or program extracted from a broadcast channel and/or program that is viewable on the broadcast receiver.

### BACKGROUND OF THE INVENTION

1. Field of the Invention

The present invention relates to a broadcast receiver and a control method for a broadcast receiver.

2. Description of the Related Art

In recent years, electronic program guide (hereinafter referred to as “EPG”) information has been provided for digital satellite broadcasting and ground-based broadcasting. EPG is provided, for example, by a broadcast program information multiplexing system. In general, EPG displays program information for each broadcast station. For example, Japanese Patent Laid-Open No. 2001-078110 discloses a technique for displaying a viewable program only by a broadcast receiver being viewed by a user based on the user's broadcast contract information in order to enhance the convenience of EPG.

For example, in an environment such as a home network through which a plurality of broadcast instruments (broadcast receivers) are connected, a program viewable by a user may be different for each broadcast instrument due to different contract for a fee-based broadcasting for each broadcast instrument. However, Japanese Patent Laid-Open No. 2001-078110 discloses a technique for easily recognizing a program that is viewable on an independent broadcast instrument, but does not disclose a technique by which a user recognizes a program viewable on each broadcast instrument in an environment where a plurality of broadcast instruments are connected. Therefore, in order for a user to know whether or not a program can be viewed by other broadcast devices on the home network for example, the user may have to confirm the electronic program guide for each discrete broadcast instrument, resulting in considerable time loss.

### SUMMARY OF THE INVENTION

The present invention provides a broadcast receiver having an interface capable of communicating with at least one other broadcast receiver and a display unit for displaying the electronic program guide, the broadcast receiver has a storage unit configured to store first broadcast information for specifying a broadcast channel and/or program that is viewable on the broadcast receiver, an acquisition unit configured to acquire second broadcast information from the other broadcast receiver for specifying a broadcast channel and/or program that is viewable on the other broadcast receiver, an extraction unit configured to extract a broadcast channel and/or program from the first and second broadcast information that is not viewable on one broadcast receiver and viewable on the other broadcast receiver, and a generation unit configured to generate the electronic program guide that a user can distinguish a broadcast channel and/or program extracted from a broadcast channel and/or program that is viewable on the broadcast receiver.

Further features of the present invention will become apparent from the following description of exemplary embodiments with reference to the attached drawings.

### BRIEF DESCRIPTION OF THE DRAWINGS

FIG. 1 is a system configuration diagram of a home network according to an embodiment of the present invention.

FIG. 2 is an internal configuration diagram of a broadcast receiver according to an embodiment of the present invention.

FIG. 3 is a viewable broadcast information table held by the broadcast receiver.

FIG. 4 is a viewable broadcast difference information table held by the broadcast receiver.

FIG. 5 is a flowchart showing the flow of electronic program guide generation processing by the broadcast receiver.

FIG. 6 is an example of an electronic program guide to be generated by the broadcast receiver.

FIG. 7 is an example of an electronic program guide to be generated by the broadcast receiver.

FIG. 8 is an example of an electronic program guide to be generated by the broadcast receiver.

### DESCRIPTION OF THE EMBODIMENTS

Hereinafter, embodiments of the present invention will now be described with reference to the accompanying drawings. An exemplary embodiment of the present invention includes a system such as one in which a plurality of the broadcast receivers are connected to an in-home network.

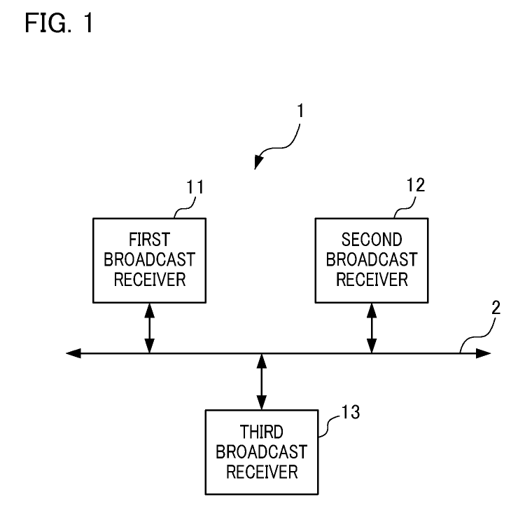

FIG. 1 is an exemplary configuration of a home network 1 according to an embodiment of the present invention. The home network 1 includes a network line 2, a first broadcast receiver (broadcast receiver) 11, a second broadcast receiver 12, and a third broadcast receiver 13. Each of the broadcast receivers 11, 12, and 13 is connected via the network line 2. Each of the broadcast receivers 11, 12, and 13 includes a tuner capable of receiving a broadcast of a predetermined broadcast carrier (e.g., ground-based broadcasting, broadcast satellite (BS) digital broadcasting, 110 degree communication satellite (CS) digital broadcasting, cable television (CATV), or the like), and can output video contents obtained by receiving and demodulating a broadcast by the tuner.

Examples of a standard for constituting a home network (referred to as a “LAN”) shown in FIG. 1 include Ethernet (registered trademark). It goes without saying that a home network can be configured employing other communication standards. In a network that is employed in the present embodiment, however, the other configuration may be contemplated such that at least two broadcast receivers are connected to a network using a transmission standard such as, for example, HDMI (High-Definition Multimedia Interface) or IEEE1394.

Hereinafter, with reference to the first broadcast receiver 11, a broadcast receiver according to an embodiment of the present invention will be described with regard to an exemplary configuration to enable the output of an electronic program guide.

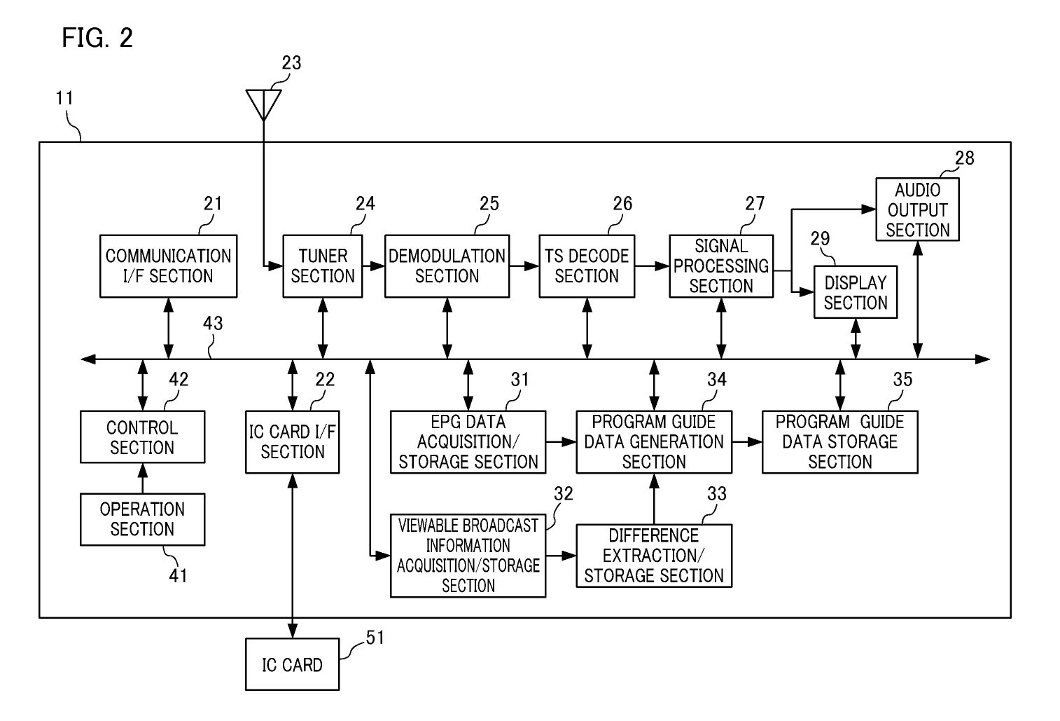

FIG. 2 is an exemplary internal configuration of the first broadcast receiver 11 (hereinafter referred to as “broadcast receiver 11”). Firstly, the broadcast receiver 11 includes an operation section 41, a control section 42, a communication I/F (interface) section 21, and the IC card I/F section 22.

The operation section 41 receives a station-selection operation and the like carried out by a user on the broadcast receiver 11, and outputs an operation signal to the control section 42. The control section 42 receives an operation signal performed on the operation section 41, and executes a station-selection control. The control section 42 includes a microcomputer consisting of, for example, CPU, ROM, RAM, and the like, and executes various control processes. When the control section 42 communicates with each section provided within the broadcast receiver 11, an internal bus 43 is used.

The communication I/F section 21 is an interface for connecting with the network line 2 constituting the home network 1. For example, the communication I/F section 21 includes a hardware device corresponding to a physical layer and a program corresponding to a predetermined software layer for connecting with the network line 2 for communication. The IC card I/F section 22 reads out a cryptographic key and contract information held in an IC card 51 based on a request from various sections constituting the broadcast receiver 11, and transmits such information to various sections. The IC card 51 also receives a command from various sections, and returns a response based on information in the IC card 51. The IC card 51 refers to a B-CAS card is to decode a code applied to a broadcast of a broadcast carrier such as, for example, BS digital broadcasting, 110 degree CS digital broadcasting, and ground-wave digital broadcasting for viewing.

The broadcast receiver 11 also includes an antenna 23, a tuner section 24, a demodulation section 25, a TS (Transport Stream) decode section 26, a signal processing section 27, an audio output section 28, and a display section 29. Here, the sections from the antenna 23 to the display section 29 are an image processing system for receiving a broadcast wave of a predetermined broadcast carrier to ultimately output it as an image.

The antenna 23 receives a broadcast wave of a predetermined broadcast carrier. The tuner section 24 receives a signal obtained from the antenna 23. Then, the tuner section 24 obtains a signal component corresponding to a broadcast station specified by a user from a received signal by performing station-selection processing in accordance with the station-selection control of a control section 41 to be described below. The demodulation section 25 receives a signal component obtained by the tuner section 24, and executes demodulation processing relative to modulation applied upon transmission so as to obtain a baseband signal. A TS decode section 26 descrambles the baseband signal that has been subjected to scramble processing.

The signal processing section 27 receives a signal that has been subjected to descramble processing by the TS decode section 26. The signal processing section 27, first, executes decoding processing on a compression-coded signal so as to obtain a predetermined type of data. Furthermore, the signal processing section 27 performs other various signal processing operations also. Examples of such signal processing include pixel number conversion processing, IP conversion processing, and the like.

The audio output section 28 outputs audio data that has been subjected to decoding processing by the signal processing section 27. The display section 29 outputs image data that has been subjected to decoding processing by the signal processing section 27. A display device employed for the display section 29 is not particularly limited. Examples of an employable display device include a cathode-ray tube, liquid crystal display, plasma display, FED, organic EL, SED, and the like. The acronyms of “FED,” “EL,” and “SED,” stand for Field Emission Display, Electro Luminescence, and Surface-Conduction Electron-emitter Display, respectively.

The broadcast receiver 11 also includes an EPG data acquisition/storage section (storage unit) 31, a (viewable) broadcast information acquisition/storage section (acquisition unit) 32, a difference extraction/storage section (extraction unit) 33, an electronic program guide data generation section (generation unit) 34, and an electronic program guide data storage section 35. Here, the sections from the EPG data acquisition/storage section 31 to the electronic program guide data storage section 35 are a data processing system for generating electronic program guide data.

The EPG data acquisition/storage section 31 specifies and stores EPG data (electronic program guide information) corresponding to a broadcast carrier capable of being received by the broadcast receiver 11. The broadcast information acquisition/storage section 32 acquires broadcast station information that is viewable on the broadcast receiver 11, and stores a broadcast information table. Furthermore, in the present embodiment, the broadcast information acquisition/storage section 32 also acquires broadcast station information that is viewable on the other broadcast receivers (second broadcast receiver 12 and third broadcast receiver 13) connected to the home network 1. In this case, the broadcast information acquisition/storage section 32 also stores a broadcast information table that is viewable on the other broadcast receivers.

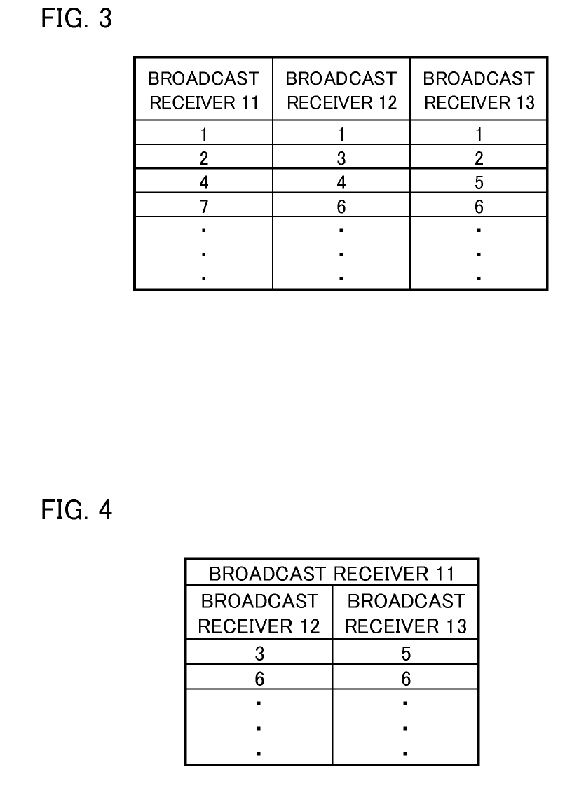

FIG. 3 is an example of a broadcast information table showing a list of broadcast information that is viewable on each of the broadcast receivers connected to the home network 1. As used herein, “viewable broadcast information” refers to information consisting of collected identifiers for uniquely specifying a broadcast station (channel) and program that is viewable on a broadcast receiver. In the example shown in FIG. 3, the identifiers such as the name or the allocated number of a broadcast receiver connected to the home network 1 are first placed at the top of the table. For each broadcast receiver, a viewable broadcast station and program to be broadcasted by the broadcast station are placed as a list.

The difference extraction/storage section 33 extracts the difference between a broadcast information that is viewable on the broadcast receiver 11 and a broadcast information that is viewable on the other broadcast receivers configured on the same home network as that of the broadcast receiver 11, and stores a broadcast difference information table that is viewable on a user.

FIG. 4 is an example of a broadcast difference information table showing a list of broadcast information that is viewable on each of the broadcast receivers connected to the home network 1. As used herein, “broadcast difference information” refers to information consisting of collected identifiers for a broadcast station or program that is not viewable on the broadcast receiver 11 and viewable on the other broadcast receivers. In the example shown in FIG. 4, in each of the broadcast receivers on the home network 1, the identifiers such as name or allocated number of a broadcast receiver being currently viewed by a user are first placed at the top of the table. At the lower part thereof, the identifiers such as the name or the allocated number of the other broadcast receivers (second broadcast receiver 12 and third broadcast receiver 13) on the home network 1 are placed. At the lower part where the identifiers of each of the other broadcast receivers (second broadcast receiver 12 and third broadcast receiver 13) are placed, a broadcast station that is not viewable on the broadcast receiver 11 and viewable on each of the broadcast receivers and a program to be broadcast by the broadcast station are placed as a list. In other words, broadcast difference information in the present embodiment is a set of broadcasting or programs, for example, that are not viewable on the broadcast receiver 11 and viewable on the broadcast receiver 12, which is generated for each combination of the two broadcast receivers.

The electronic program guide data generation section 34 can identify EPG data and viewable broadcast difference information which have been acquired and extracted by the EPG data acquisition/storage section 31, the broadcast information acquisition/storage section 32, and the difference extraction/storage section 33 described above, and generates an electronic program guide based on the information. The electronic program guide data storage section 35 stores the electronic program guide generated by the electronic program guide data generation section 34. The electronic program guide stored in the storage section 35 is displayed on the display section 29 in accordance with a display request from a user.

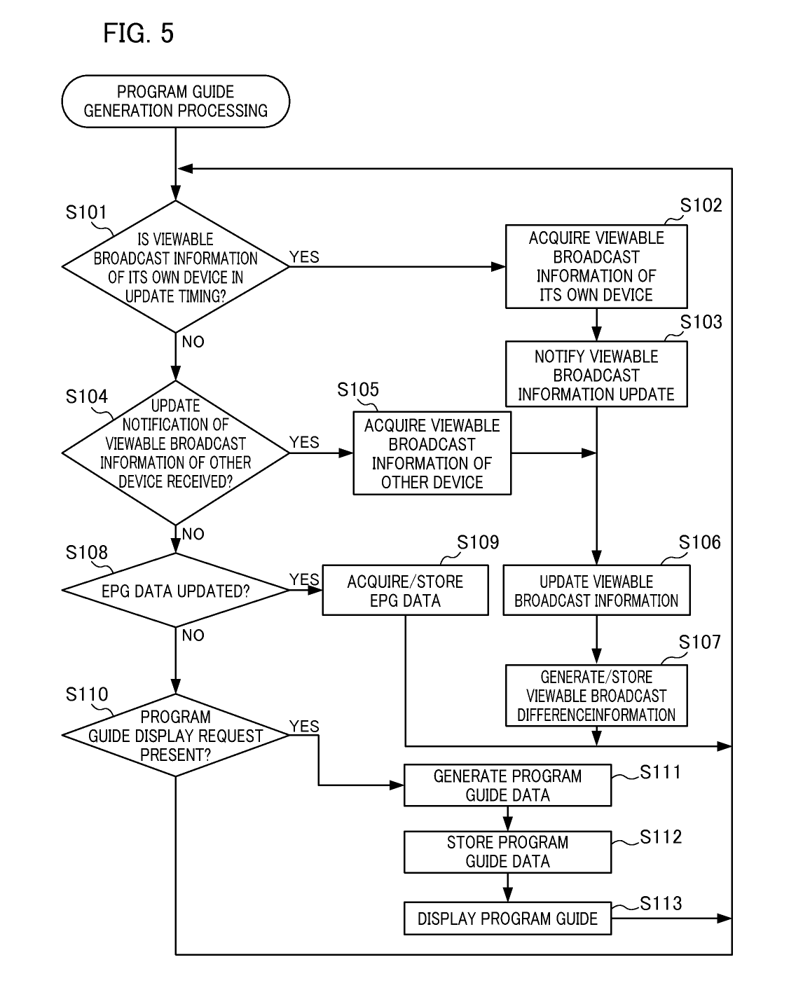

Next, with reference to a flowchart, the flow of the processing procedure executed by the broadcast receiver 11 of the present invention will be described in relation to the output of the electronic program guide. FIG. 5 is a flowchart showing the flow in which the electronic program guide of the broadcast receiver 11 is generated (i.e., program guide generation processing).

First, in step S101, the control section 42 determines whether or not broadcast information that is viewable on the broadcast receiver 11 (in FIG. 5, referred to as “own device”) should be updated (i.e., is viewable broadcast information of its own device in update timing?). When the obtained determination result is that broadcast information should be updated, the subsequent procedures in steps S102, S103, S106, and S107 are sequentially executed. For a determination whether or not broadcast information should be updated, for example, the control section 42 includes a timer for measuring information update timing and the timer executes the measurement of a predetermined time. When the time period measured by the timer has elapsed, the control section 42 executes a determination. The timing of the determination standard in step S101 may be performed at a constant time interval by the timer as described above, or may also be performed when the power supply of the broadcast receiver 11 is turned ON/OFF, or when a contract information is changed. In addition, a plurality of conditions may also be combined, which is not particularly limited thereto.

Next, in step S102, the broadcast information acquisition/storage section 32 acquires and stores the broadcast information that is viewable on the broadcast receiver 11. Here, a contract confirmation command is used for the acquisition of the viewable broadcast information. As used herein, “contract confirmation command” refers to a command for transmitting contract confirmation information contained in an EIT (Event Information Table) or a SDT (Service Description Table) to the IC card 51. The control section 42 transmits a contract confirmation command stored in the broadcast information acquisition/storage section 32 to the IC card 51, whereby contract confirmation of a broadcast station or program can be performed according to the contents of its response. The EIT is a table in which program-related information such as program titles, broadcast date, and program contents is described. The SDT is a table in which information relating to data explaining a service in a system, for example, a service name, or service providers is described. This information as well as the audio data and the video data for a program are transmitted from a broadcast station. The control section 42 confirms whether or not the broadcast station can be viewed according to the contents of the response from the IC card 51, and updates the contents of a broadcast information table as shown in FIG. 3.

Next, in step S103, the control section 42 provides notification about the broadcast information that is viewable on the broadcast receiver 11 to the other broadcast receivers (second broadcast receiver 12 and third broadcast receiver 13) (in FIG. 5, referred to as “other devices”) via the communication I/F section 21 by broadcasting. Here, the control section 42 sequentially executes step S106 and step S107 after the execution of step S103. These steps will be described below after the explanation of step S105 below.

Next, in step S104 (i.e., update notification of viewable broadcast information of other device received?), the control section 42 first waits for an update notice about viewable broadcast information to be submitted from the other broadcast receivers connected to the home network 1. The instructions for transmitting viewable broadcast information can also be given to other broadcast receivers. In such a case, the control section 42 may issue a command for instructing the transmission of broadcast information via the communication I/F section 21 to other broadcast receivers. Here, the control section 42 sequentially executes the procedures of step S105, step S106, and step S107 when the control section 42 receives an update notice.

Next, in step S105, the broadcast information acquisition/storage section 32 acquires broadcast information that is viewable on the other broadcast receivers. Furthermore, in step S106, the broadcast information acquisition/storage section 32 updates and stores the broadcast information table as shown in FIG. 3.

Next, in step S107, the difference extraction/storage section 33 extracts the differences between viewable broadcast for each of the broadcast receivers based on the broadcast information table, and updates the contents of the broadcast difference information table as shown in FIG. 4. After the procedure of step S107 is executed, the process returns to step S101.

In step S108, the control section 42 executes step S109 when it receives updated content for EPG data. Furthermore, in step S109, the EPG data acquisition/storage section 31 acquires and stores the EPG data. After the procedure of step S109 is executed, the process returns to step S101.

Next, in step S110 (i.e., program guide display request present?), a user performs an electronic program guide confirmation operation on the operation section 41. When the operation section 41 transmits a display request signal for an electronic program guide to the control section 42, step S111, step S112, and step S113 are sequentially executed.

Next, in step S111, the electronic program guide data generation section 34 generates an electronic program guide using EPG data and broadcast difference information. Furthermore, in step S112, the electronic program guide data storage section 35 stores a generated electronic program guide. In step S113, the control section 42 outputs the stored EPG data to the display section 29. After the procedure of step S113 is executed, the process returns to step S101.

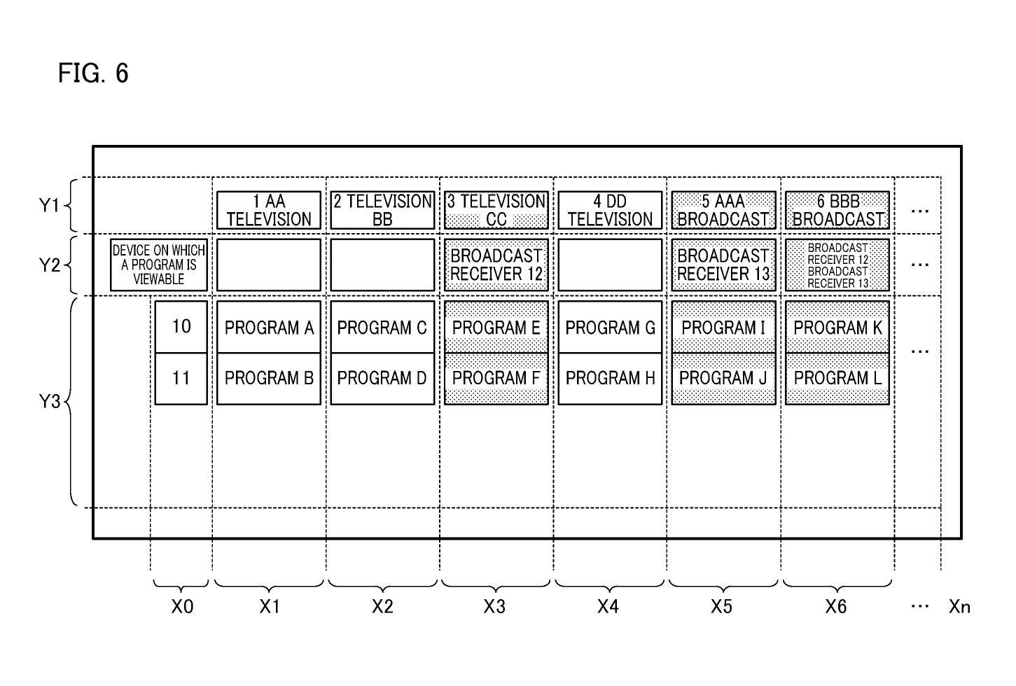

FIG. 6 is an example of a basic integrated electronic program guide to be generated and output in a display by the processing procedure shown in FIG. 5. In FIG. 6, an exemplary electronic program guide to be displayed on the broadcast receiver 11 based on the broadcast difference information table as shown in FIG. 4 is included.

In FIG. 6, the entire area for the integrated electronic program guide is split, from top to bottom, into the area Y1 where broadcast stations are displayed, the area Y2 where viewable broadcast receivers are displayed, and the area Y3 where program information is displayed. In addition, the entire area of the integrated electronic program guide is split, from left to right, into the area X0 where the time zone is displayed and the areas X1 to Xn where a program is displayed in broadcast station units. In the viewable broadcast difference information shown in FIG. 4, broadcast stations (in FIG. 4, corresponding to 3, 5, and 6) that are not viewable on the broadcast receiver 11 and viewable on the other broadcast receivers 12, and 13 are displayed by varying the background color so as to be visible to a user. Furthermore, a viewable broadcast receiver is displayed on the area Y2.

Although broadcast stations are highlighted by varying the background color of the broadcast stations in the above example, the display format is not particularly limited. For example, the display format can be rendered recognizable by a user by changing the color of the frame of the broadcast stations or displaying the broadcast stations in the form of characters. In addition, the display type of the viewable broadcast receiver is not particularly limited, and any user recognizable type may be used. For example, the instrument ID or instrument name set by the instrument manufacturer may be used, or a user-set name, or icon characterized by each instrument, or a room name in home where the instrument is installed may be displayed.

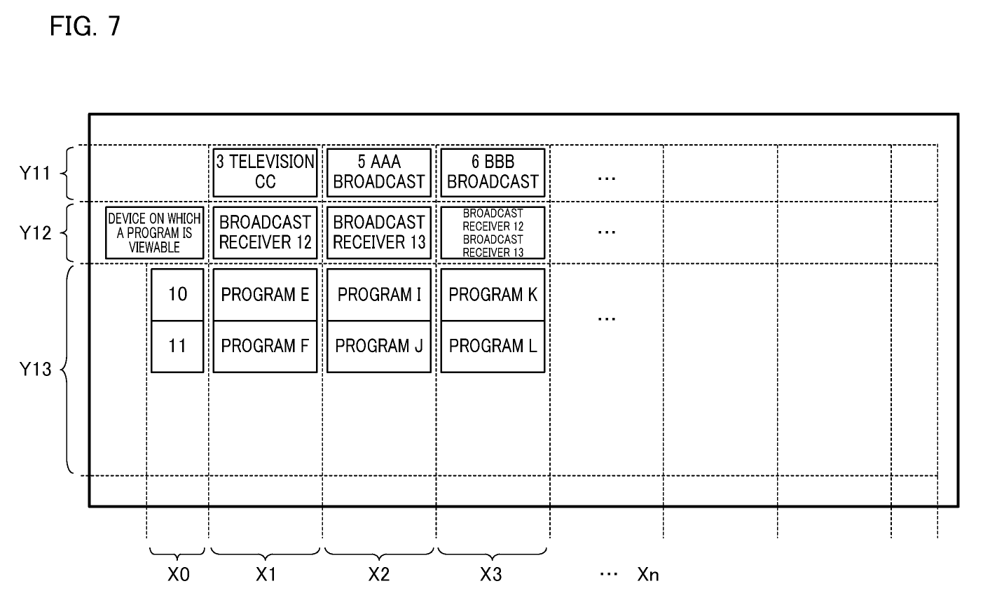

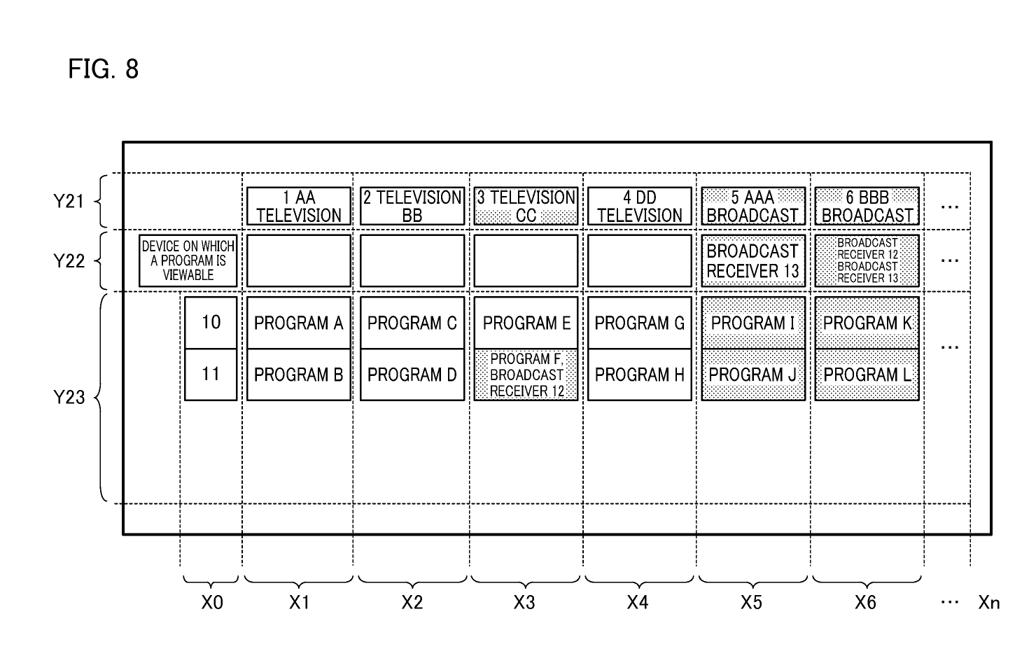

The display format of the electronic program guide is not limited to the above examples, and the electronic program guide to be output in a display may be other than the above configuration. Two examples of other electronic program guides (i.e., FIGS. 7 and 8) are given in the following. In FIGS. 7 and 8, the entire area for the integrated electronic program guide is split, from top to bottom, into the area Y11(Y21) where broadcast stations are displayed, the area Y12(Y22) where viewable broadcast receivers are displayed, and the area Y13(Y23) where program information is displayed. In addition, the entire area of the integrated electronic program guide is split, from left to right, into the area X0 where the time zone is displayed and the areas X1 to Xn where a program is displayed in broadcast station units.

FIG. 7 is an example of an electronic program guide on which the difference between the broadcast receiver 11 and other broadcast receivers 12 and 13 is displayed. In other words, in FIG. 7, channels and programs that are not viewable on the broadcast receiver 11 are hidden, and only broadcast stations and programs that are viewable on other broadcast receivers 12 and 13 are displayed. With this arrangement, when there are a number of broadcast channels, the programs and broadcast channels that are not viewable on the reference device but viewable on other broadcast receivers may be easily visually recognized.

FIG. 8 is an example of an electronic program guide when there is a contract for each program. FIG. 8 shows that program F of “3 Television CC” in the station display area of the area Y21 is not viewable on the broadcast receiver 11 but viewable on the broadcast receiver 12. Here, the program is highlighted by changing the background color of the program information display area Y23 instead of changing the entire area of the broadcast station, and the device on which a broadcast station is viewable is displayed at the bottom of the program information. With these configurations, the electronic program guides shown in FIGS. 6, 7, and 8 can be switched and displayed in accordance with instructions from the user, whereby the user convenience can be further improved.

As described above, the present invention provides a broadcast receiver enables readily recognizing whether there is any program or channel that is viewable on the other broadcast receivers that are communicatively connected and a control method for a broadcast receiver.

The broadcast receiver according to an exemplary embodiment described above, which is provided with a display section, corresponds to what is commonly referred to as a “television”. However, the present invention is not necessarily a television having a display section. For example, a broadcast recorder or computer mounted with an interface capable of communicating with a tuner has also become common. For such a device, an electronic program guide can be generated and displayed on an external display section. That is, the broadcast receiver of the present invention is not limited to television.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-262239 filed Oct. 8, 2008 which are hereby incorporated by reference herein it their entirety.

What is claimed is:

1. A broadcast receiver having an interface capable of communicating with at least one other broadcast receiver and a display unit for displaying an electronic program guide, the broadcast receiver comprising:
a storage unit configured to store first broadcast information for specifying a broadcast channel and/or program that is viewable on the broadcast receiver;
an acquisition unit configured to acquire second broadcast information from the other broadcast receiver for specifying a broadcast channel and/or program that is viewable on the other broadcast receiver;
an extraction unit configured to extract a broadcast channel and/or program from the first and second broadcast information that is not viewable on the broadcast receiver and viewable on the other broadcast receiver; and
a generation unit configured to generate the electronic program guide that a user can distinguish a broadcast channel and/or program extracted from a broadcast channel and/or program that is viewable on the broadcast receiver.

2. The broadcast receiver according to claim 1, wherein the generation unit generates the electronic program guide for displaying an extracted broadcast channel and/or program that is viewable on the broadcast receiver being hidden.

3. A control method for a broadcast receiver having an interface capable of communicating with at least one other broadcast receiver and a display unit for displaying the electronic program guide, the control method comprising:
storing first broadcast information for specifying a broadcast channel and/or program that is viewable on the broadcast receiver;
acquiring second broadcast information from the other broadcast receiver for specifying a broadcast channel and/or program that is viewable on the other broadcast receiver;
extracting a broadcast channel and/or program from the first and second broadcast information that is not viewable on the broadcast receiver and viewable on the other broadcast receiver; and
generating the electronic program guide that a user can distinguish a broadcast channel and/or program extracted from a broadcast channel and/or program that is viewable on the broadcast receiver.

4. The control method for the broadcast receiver according to claim 3, wherein the generation step generates an electronic program guide for displaying an extracted broadcast channel and/or program that is viewable on the broadcast receiver being hidden.
